(19) United States
(12) Patent Application Publication
(10) Pub. No.: US 2012/0085751 A1
(43) Pub. Date: Apr. 12, 2012

(54) ASSEMBLY UNIT FOR AN INDUCTION HOB, INDUCTION HOB AND METHOD FOR MANUFACTURING AN ASSEMBLY UNIT

(75) Inventors: Laurent Jeanneteau, Compiegne (FR); Thibaut Rigolle, Forli (IT); Alex Viroli, Forli (IT); Massimo Zangoli, Santarcangelo di Romagna (IT); Ulrich Häutle, Illertissen (DE); Klaus Schlötterer-Fratoianna, Diespeck (DE)

(73) Assignee: ELECTROLUX HOME PRODUCTS CORPORATION, N.V., Zaventem (BE)

(21) Appl. No.: 12/994,700

(22) PCT Filed: May 28, 2009
(86) PCT No.: PCT/EP2009/003822

§ 371 Date: Jul. 21, 2011

(30) Foreign Application Priority Data
May 30, 2008 (EP) 08009921.1

(51) Int. Cl. H05B 6/12

(52) U.S. Cl. 219/620

(57) ABSTRACT

The invention relates to an assembly unit for an induction hob with at least one induction element, comprising a) at least one carrying element for carrying the circuits and/or devices for supplying the at least one induction element. The at least one carrying element comprises a base area and side areas protruding upwards from the base area. The at least one carrying element is connectable with at least one further carrying element along a side area, and the side areas comprise connection elements for connection with the at least one further carrying element, preferably at least one power wire slot for inserting at least one power supply wire and/or preferably at least one signal wire slot for inserting at least one signal wire. Furthermore, the invention relates to a method for manufacturing an assembly unit.

The invention relates to an assembly unit for an induction hob comprising at least one carrying element for carrying the circuits and/or devices for supplying the induction element.

Induction hobs are produced with a variable number of cooking zones. For example, there are induction hobs with two zones or induction hobs with three or four zones. Normally, for these two different induction hobs, different carrying elements are necessary.

Therefore, it is an object of the invention to propose a new assembly unit and/or a new induction hob and a corresponding method, which is/are usable for a variable number of cooking zones.

This object is solved by an assembly unit according to claim 1, an induction hob according to claim 9 and a method for manufacturing an assembly unit according to claim 11. Advantageous embodiments are described particularly in the dependent claims.

According to claim 1, the invention relates to an assembly unit for an induction hob with at least one induction element, comprising a) at least one carrying element for carrying the circuits and/or devices for supplying the at least one induction element, b) wherein the at least one carrying element comprises a base area and side areas protruding upwards from the base area, c) wherein the at least one carrying element is connectable with at least one further carrying element along a side area, d) wherein the side areas comprise d1) connection elements for connection with the at least one further carrying element, d2) preferably at least one power wire slot for inserting at least one power supply wire and/or d3) preferably at least one signal wire slot for inserting at least one signal wire.

The invention according to claim 1 allows a flexible usage of the carrying element, as it comprises the necessary elements to combine several carrying elements to an assembly unit. The induction element is preferably at least one induction coil.

The proposed assembly unit reduces the manufacturing complexity by reducing the amount of base parts. New versions can be created at least relatively easy, without generating too many new components, which increases and eases the development of the assembly unit. Furthermore, the complexity can be reduced, by limiting or reducing the amount of spare parts.

Preferably, the carrying element is formed like a box, wherein the base area has an at least substantially rectangular shape, wherein the carrying element comprises four side areas protruding upwards from the base area, wherein a) a first side area forms a first side wall, b) a second side area forms a second side wall, c) a third side area forms a third side wall opposite to the first side wall and where d) a forth side area forms a forth side wall opposite to the second side wall, wherein preferably the side of the base area adjacent to the first side wall is shorter and/or smaller then the side of the base area adjacent to the second side wall and/or wherein different carrying elements have the same connection elements. This embodiment eases the connecting of a carrying element with further carrying elements, wherein at least relatively little space is necessary.

In an advantageous embodiment, a first and a second carrying element are connectable and/or connected along their first side walls, wherein especially the first carrying element is turned with respect to the second carrying element by 180° and/or the second side wall of the first carrying element is connectable and/or connected with the forth side wall of a third carrying element.

Preferably, the power supply wire is usable for passing power to at least one further carrying element and/or the signal wire is usable for passing signals to at least one further carrying element.

In an advantageous embodiment, at least one connection element, especially a cone shaped element or a hook or a slot, has a corresponding counterpart in the opposite side area and/or connection elements, especially cone shaped elements or hooks or slots are used for connecting a carrying element with another carrying element.

In an advantageous embodiment, at least one side area comprises at least one connection element, especially a cone shaped element or a hook or a slot, wherein the at least one connection element, especially a cone shaped element or a hook or a slot, has a corresponding counterpart in the opposite side area and/or in the same area and/or wherein the least one connection element or connection elements, especially cone shaped elements or hooks or slots, are used for connecting a carrying element with another carrying element.

Preferably, one wire slot is arranged in the center of a side area and/or two wire slots are arranged with the same distance from the center of a side area. In an advantageous embodiment, a power box is insertable into the or a carrying unit or carrying element for distribution of the power to an adjacent carrying unit or carrying element and/or a circuit is insertable between adjacent carrying units or carrying element for distribution of the power to an adjacent carrying unit or carrying element.

Preferably, each carrying element defines the dimension and/or the orientation of the area for an induction element, especially an induction heating element, to be supplied and/or a carrying element is usable in different induction hobs which differ in their number of induction elements, especially induction heating elements. This allows a flexible usage of the carrying elements in different induction hobs and thus a lower number of different parts for different induction hobs.

According to another aspect, the invention relates to an induction hob comprising induction elements, especially induction heating elements, arranged in a row, a column or a two-dimensional matrix and/or each induction element, especially induction heating element, is, especially directly, connected with and/or arranged above a carrying element carrying the circuits and/or devices for supplying the induction element, especially the induction heating element. This means that the induction elements can be supplied with power effectively and with short cables.

Preferably, the carrying elements form a plug-in system with all components necessary for supplying the induction heating elements. This allows a cost and time-effective manufacturing.

Furthermore, the invention relates to a method for manufacturing an assembly unit according to one of the preceding claims, a) wherein at least two carrying elements are connected, b) wherein a first and a second carrying element are connected along their first side walls, where especially the first carrying element is turned with respect to the second carrying element by 180° and/or c) wherein the second side wall of the first carrying element is connected with the forth side wall of a third carrying element.

The invention will be now described in further details with references to the figures, in which

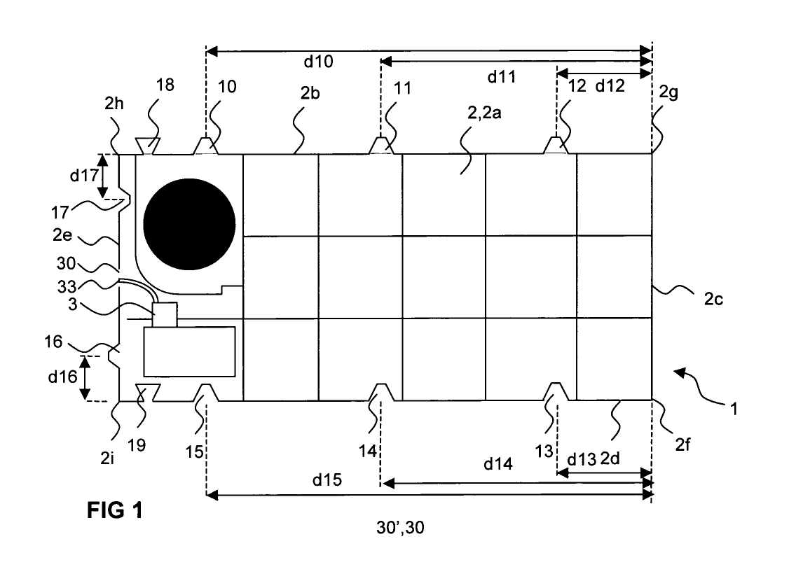

FIG. 1 describes an assembly unit according to the invention with a single carrying element,

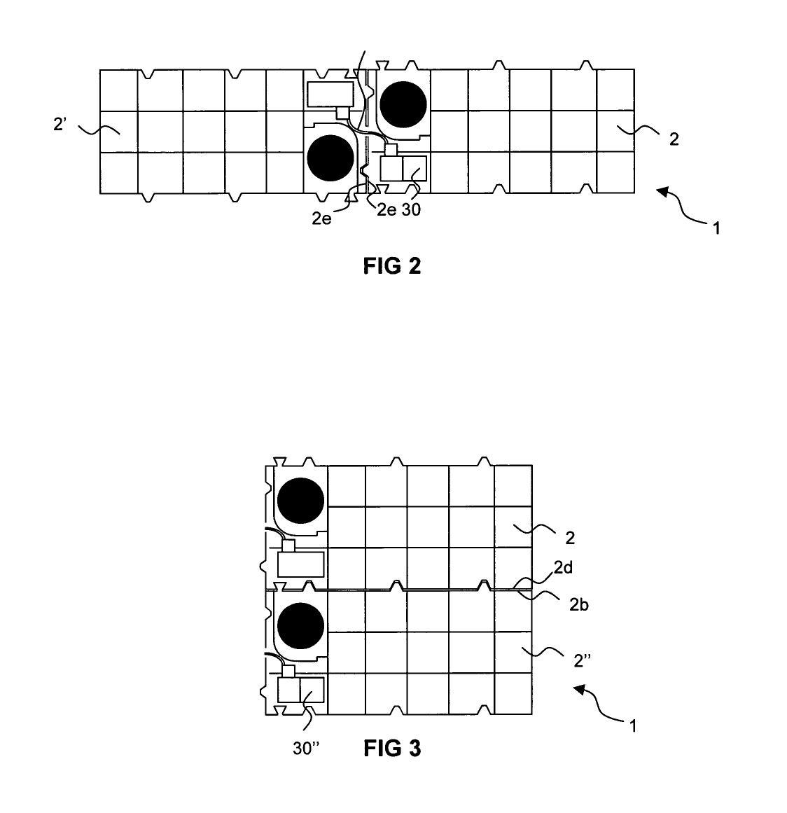

FIG. 2 describes an assembly unit according to the invention with two carrying elements arranged side by side,

FIG. 3 shows another assembly unit with two carrying elements arranged along their back sides,

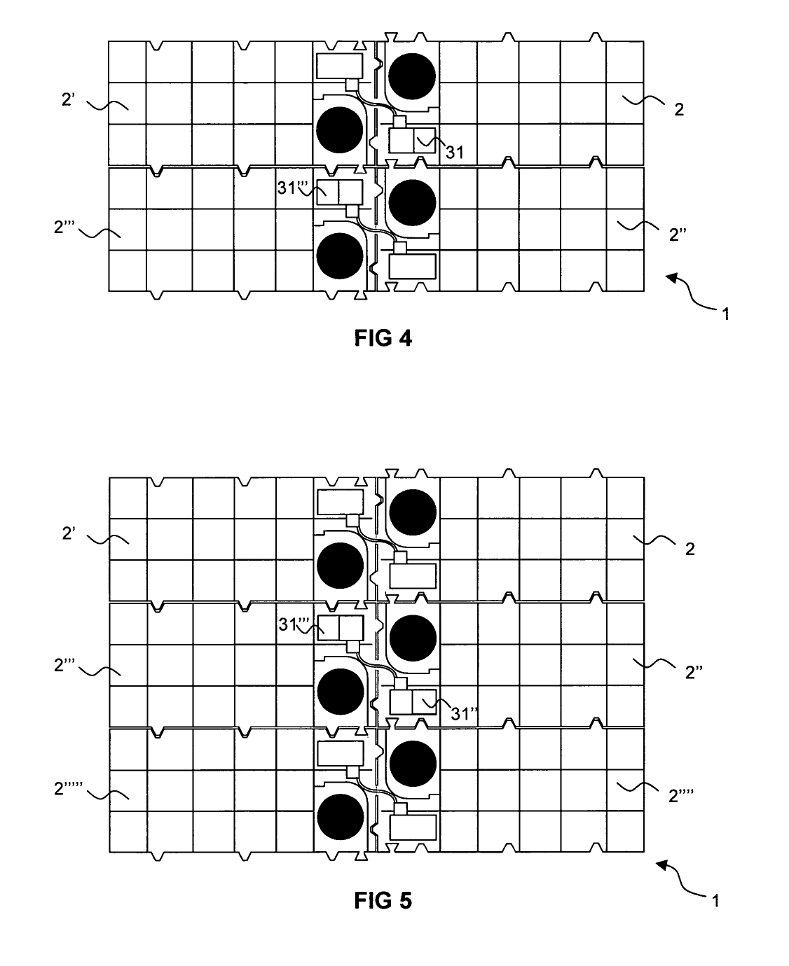

FIG. 4 shows another assembly unit according to the invention with four carrying elements arranged along their back sides and along their sides and in which

FIG. 5 shows another embodiment of an assembly unit according to the invention comprising six carrying elements arranged side by side and along their back sides.

FIG. 1 shows an assembly unit 1 comprising one carrying element 2 with circuits and/or devices 3 for supplying the induction element.

The carrying element 2 is formed like a box. The base area 2a has an at least substantially rectangular shape. The carrying element 2 comprises four side areas 2b to 2e protruding upwards from the base area 2a. The first side area 2e forms a first side wall, the second side area 2b forms a second side wall, the third side area 2c forms a third side wall opposite to the first side wall 2e and the forth side area 2d forms a forth side wall opposite to the second side wall. The side walls 2b to 2e form corners 2f to 2i, where corner 2f is arranged between side walls 2d and 2c, where corner 2g is arranged between side walls 2c and 2a, where corner 2h is arranged between side walls 2b and 2e and where corner 2i is arranged between side walls 2e and 2d.

As can be seen from FIG. 2, the carrying element 2 is connectable and connected with a further carrying element 2′ along the side 2e of the carrying element 2 and the side 2e′ of the carrying element 2′. Both carrying elements 2 and 2′ have the same connection elements 10 to 19.

The side areas 2b to 2e comprise connection elements 10 to 19 along their surfaces, where the side 2b comprises four connection elements 10, 11, 12 and 18 protruding like a cone and away from the base area 2a.

Connection element 10 has a distance d10, connection element 11 has a distance d11, connection element 12 has a distance d13 and, not shown, connection element 18 has a distance d18 from the corner 2g.

The opposite side 2d comprises four connection elements 13, 14, 15 and 19 protruding inwards in the direction of the base area 2a. The connection elements 13, 14, 15 and 19 are also formed like a cone, however, they are formed as a counterpart with respect to the connection elements 10, 11, 12 and 18.

Connection element 13 has a distance d13, connection element 14 has a distance d14, connection element 15 has a distance d15 and, not shown, connection element 19 has a distance d19 from the corner 2f.

To be able to connect two carrying elements 2 and 2″ along their corresponding sides 2d and 2b, the distance d13 is equal to the distance d12, the distance d14 is equal to the distance d11, and the distance d15 is equal to the distance d10 and the distance d18 is equal to the distance d19. Furthermore, along the short side 2e, one connection element formed like a cone with reference No. 16 is arranged, with protrudes away from the base area 2a.

In the upper part of the side area 2e, another connection element 17 is arranged, which, however, protrudes inwards into the direction of the base area 2a and which is also formed like a cone and forms a counterpart with respect to the connecting element 16.

Connection element 17 has a distance d17 from the corner 2h and connection element 16 has a distance d16 from the corner 2i.

To be able to connect two carrying elements 2 and 2′ along their sides 2e, the distance d16 is equal to the distance d17.

Furthermore, in the side area 2e, a slot 30 is provided for inserting power cables 33, which are passed from the carrying element 2 to another carrying element 2′.

The slot 30 has the same distance from corner 2h and from corner 2i.

Into this slot, also signal cables can be inserted, which transmit signals from a carrying element 2 to another carrying element 2′.

FIG. 3 shows another embodiment according to the invention, with a carrying element 2 combined with a carrying element 2″ along its lower longer side 2d. The carrying element 2″ is connected with a carrying element 2 along its upper longer side 2b.

FIG. 4 shows another embodiment of an assembly unit 1 according to the invention, with a carrying element 2 and three further carrying elements 2′, 2″ and 2′. The four carrying elements are connected with each other. The carrying element 2 is connected with the carrying element 2′ along its left side area 2e and with the carrying element 2″ along its side 2d. The three further carrying elements 2′, 2″ and 2′″ have connections in a corresponding way, so that they form two rows and two columns.

FIG. 5 shows another embodiment of the invention with the assembly unit 1 with six carrying elements 2, 2′, 2″, 2′″, 2″″ and 2′″″. The form three rows and two columns.

If a single carrying or box element is used, a cable for power supply can be placed.

If two carrying elements are connected side by side a power box 31 is inserted in one or both carrying elements and the power is passed via the wire slots, the signal wires are passed also using the wire slots 30.

If two carrying elements are connected back to back, also at least one power pox 31 is used. Furthermore, a circuit for wire distribution is used.

The box design is minimized for a simple manufacturing tool. For fixing the carrying elements side by side, besides the cone shape, hooks and/or slots can be added. The fixing back to back is made by a cone shape.

For manufacturing of the assembly unit 1, the needed number of carrying elements 2 is simply pushed into each other, and, afterwards, the necessary cables are inserted.

If necessary, also power boxes 31 and circuits for wire distribution are included.

Each carrying element 2 defines the dimension and the orientation of the area for an induction heating element to be supplied, which is not shown in the figures. The carrying elements 2 are usable in different induction hobs which differ in their number and/or arrangement of heating elements.

The induction hob can comprise induction heating elements which can be arranged in a row, a column or a two-dimensional matrix.

Each induction heating element is connected and arranged above a carrying element 2 carrying the circuits and devices 3 for supplying the induction heating element.

The carrying elements 2 form a plug-in system with all components necessary for supplying the induction heating elements.

### LIST OF REFERENCE SIGNS

1 assembly unit
2, 2′, 2″
2′″, 2″″,
2′″″ carrying elements
2a base area
2b-2e side areas
2f-2h corners
3 induction supplying devices
10-19 connection elements
30 wire slot
31 power box
33 power supply wire
d10-d17 distances

1-11. (canceled)

12. An assembly unit for an induction hob with at least one induction element, comprising:
a) at least one carrying element for carrying the circuits and/or devices for supplying the at least one induction element;
b) wherein the at least one carrying element comprises a base area and side areas protruding upwards from the base area;
c) wherein the at least one carrying element is connectable with at least one further carrying element along a side area;
d) wherein the side areas comprise:
d1) connection elements for connection with the at least one further carrying element,
d2) preferably at least one power wire slot for inserting at least one power supply wire; and/or
d3) preferably at least one signal wire slot for inserting at least one signal wire.

13. The assembly unit according to claim 12, wherein:
a) the carrying element is formed like a box;
b) the base area has an at least substantially rectangular shape;
c) the carrying element comprises four side areas protruding upwards from the base area, wherein:
c1) a first side area forms a first side wall;
c2) a second side area forms a second side wall;
c3) a third side area forms a third side wall opposite to the first side wall; and
c4) a forth side area forms a forth side wall opposite to the second side wall; and
d) preferably different carrying elements have the same connection elements.

14. The assembly unit according to claim 12, wherein:
a) a first and a second carrying element are connectable and/or connected along the first side wall, wherein especially the first carrying element is turned with respect to the second carrying element by 180°; and/or
b) the second side wall of the first carrying element is connectable and/or connected with the forth side wall of a third carrying element.

15. The assembly unit according to claim 12, wherein:
a) the power supply wire is usable for passing power from and/or to at least one further carrying element; and/or
b) the signal wire is usable for passing signals from and/or to at least one further carrying element.

16. The assembly unit according to claim 12, wherein:
a) at least one side area comprises at least one connection element, especially a cone shaped element or a hook or a slot,
b) the at least one connection element, especially a cone shaped element or a hook or a slot, has a corresponding counterpart in the opposite side area and/or in the same area and/or the least one connection element; and/or
c) the at least one connection element or the connection elements, especially cone shaped elements or hooks or slots, is/are used for connecting a carrying element with another carrying element.

17. The assembly unit according to claim 12, wherein:
a) one wire slot is arranged in the center of a side area; and/or
b) two wire slots are arranged with the same distance from the center of a side area.

18. The assembly unit according to claim 12, wherein:
a) a power box is insertable into the or a carrying unit or carrying element for distribution of the power to an adjacent carrying unit or carrying element; and/or
b) a circuit is insertable between adjacent carrying units or carrying elements for distribution of the power to an adjacent carrying unit or carrying element.

19. The assembly unit according to claim 12, wherein:
a) each carrying element defines the dimension and/or the orientation of the area for an induction element, especially an induction heating element, to be supplied; and/or
b) a carrying element is usable in different induction hobs which differ in their number of induction elements, especially induction heating elements.

20. An induction hob with an assembly unit according to claim 12, wherein:
a) the induction hob comprises induction elements, especially induction heating elements, arranged in a row, a column or a two-dimensional matrix; and/or
b) each induction element, especially induction heating element, is, especially directly, connected with and/or arranged above a carrying element carrying the circuits and/or devices for supplying the induction element, especially the induction heating element.

21. The induction hob with an assembly unit according to claim 20, wherein the carrying elements form a plug-in system with all components necessary for supplying the induction elements.

22. A method for manufacturing an assembly unit according to claim 12, wherein:
a) at least two carrying elements are connected;
b) a first and a second carrying element are connected along their first side walls, where especially the first carrying element is turned with respect to the second carrying element by 180°; and/or
c) the second side wall of the first carrying element is connected with the forth side wall of a third carrying element.
